(19) United States
(12) Patent Application Publication
(10) Pub. No.: US 2019/0297576 A1
(43) Pub. Date: Sep. 26, 2019

(54) Power-Saving Mechanism By Cross-Slot Scheduling In Mobile Communications

(71) Applicant: MediaTek Singapore Pte. Ltd., Singapore (SG)

(72) Inventors: Pradeep Jose, Cambridge (GB); Pavan Santhana Krishna Nuggehalli, San Jose, CA (US)

(21) Appl. No.: 16/361,128

(22) Filed: Mar. 21, 2019

Related U.S. Application Data
(60) Provisional application No. 62/645,876, filed on Mar. 21, 2018.

(51) Int. Cl. H04W 52/02

(52) U.S. Cl. CPC H04W 52/0229; H04W 76/28

(57) ABSTRACT

Various solutions for power-saving mechanism by cross-slot scheduling with respect to user equipment and network apparatus in mobile communications are described. An apparatus may determine whether a first condition is triggered. The apparatus may perform a transition from a first power state to a second power state in response to the first condition being triggered. The apparatus may receive downlink information according to a cross-slot scheduling when in the second power state.

### CROSS REFERENCE TO RELATED PATENT APPLICATION(S)

The present disclosure is part of a non-provisional application claiming the priority benefit of U.S. Patent Application No. 62/645,876, filed on 21 Mar. 2018, the content of which is incorporated by reference in its entirety.

### TECHNICAL FIELD

The present disclosure is generally related to mobile communications and, more particularly, to power-saving mechanism by cross-slot scheduling with respect to user equipment and network apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR), same-slot scheduling is always expected by the user equipment (UE) on the downlink. As a result, the UE stores all symbols over the time taken to receive, decode and parse the physical downlink control channel (PDCCH). This can consume a lot of power, especially when the presence of downlink data is sporadic, as the UE is unnecessarily receiving additional symbols.

In an event that there is no downlink data for the UE scheduled in the slot, the UE may waste power to receive/store the symbols. For example, the UE may seldom have data in the connected discontinuous reception (DRX) operation. The UE will consume a lot of power for monitoring same-slot scheduling in every slot.

Accordingly, how the UE can reduce power consumption by avoiding the reception of unnecessary additional symbols is important in reducing its power consumption. Therefore, a power-saving mechanism is needed that uses cross-slot scheduling.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to power-saving mechanism by cross-slot scheduling with respect to user equipment and network apparatus in mobile communications.

In one aspect, a method may involve an apparatus determining whether a first condition is triggered. The method may also involve the apparatus performing a transition from a first power state to a second power state in response to the first condition being triggered. The method may further involve the apparatus receiving downlink information according to a cross-slot scheduling when in the second power state.

In one aspect, an apparatus may comprise a transceiver capable of wirelessly communicating with a network node of a wireless network. The apparatus may also comprise a processor communicatively coupled to the transceiver. The processor may be capable of determining whether a first condition is triggered. The processor may also be capable of performing a transition from a first power state to a second power state in response to the first condition being triggered. The processor may further be capable of receiving downlink information according to a cross-slot scheduling when in the second power state.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication apparatus and an example network apparatus in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to power-saving mechanism by cross-slot scheduling with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In LTE or NR, same-slot scheduling is always expected by the UE on the downlink. As a result, the UE stores all symbols over the time taken to receive, decode and parse the PDCCH. This can consume a lot of power, especially when the presence of downlink data is sporadic, as the UE is unnecessarily receiving additional symbols.

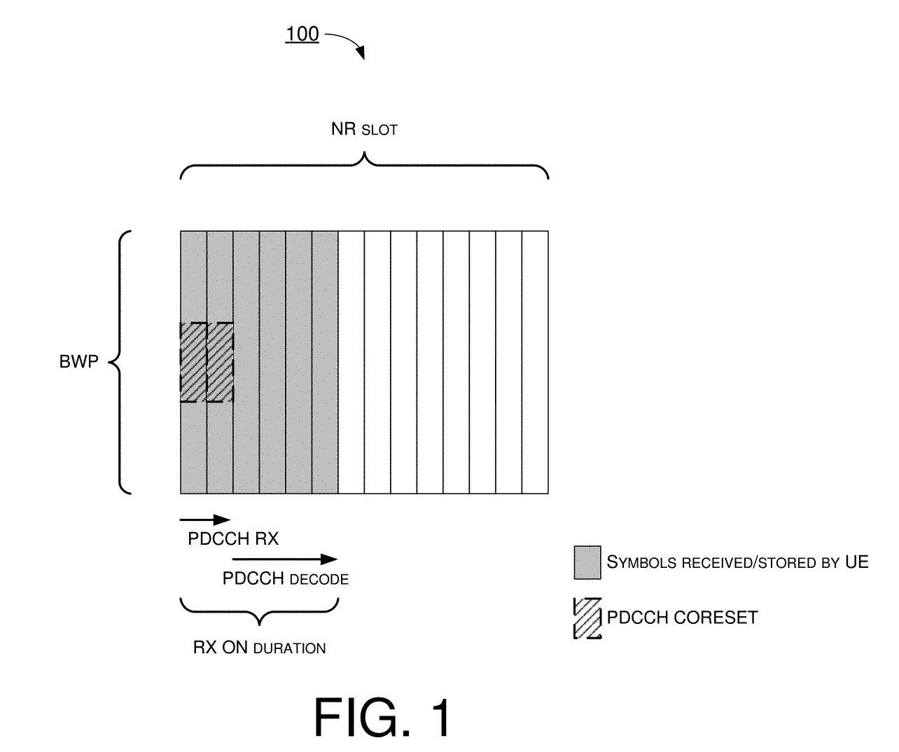

FIG. 1 illustrates an example scenario 100 under schemes in accordance with implementations of the present disclosure. Scenario 100 involves a UE and a network node, which may be a part of a wireless communication network (e.g., an LTE network, an LTE-Advanced network, an LTE-Advanced Pro network, a 5G network, an NR network, an IoT network or an NB-IoT network). In scenario 100, the network node may be configured to use same-slot scheduling for transmitting downlink information to the UE. Under same-slot scheduling, the control information (e.g., PDCCH) and the data information (e.g., physical downlink shared channel (PDSCH)) may be scheduled in the same slot. The UE may be configured to monitor/receive the PDCCH. After receiving the PDCCH, the UE may need processing time to decode and parse the PDCCH. Since the UE may assume that there may be downlink data in the slot, the UE may keep its transceiver turned on to receive/store all symbols over the time taken to decode/parse the PDCCH. After determining that there is no downlink data for the UE in the slot, the UE may be able to turn off its transceiver and stop receiving downlink information.

However, in an event that there is no downlink data (e.g., PDSCH) for the UE scheduled in the same slot, the UE may waste power to receive/store the symbols. For example, the UE may seldom have data in the connected DRX operation. The UE may consume a lot of power for monitoring same-slot scheduling in every slot. In an event that the UE knows that there will not be any PDSCH to receive/decode in the same slot as the PDCCH, the UE may be able to turn off its transceiver after the reception of the PDCCH. The UE may not need to monitor/receive additional symbols except the PDCCH. Accordingly, the UE power consumption may be significantly reduced.

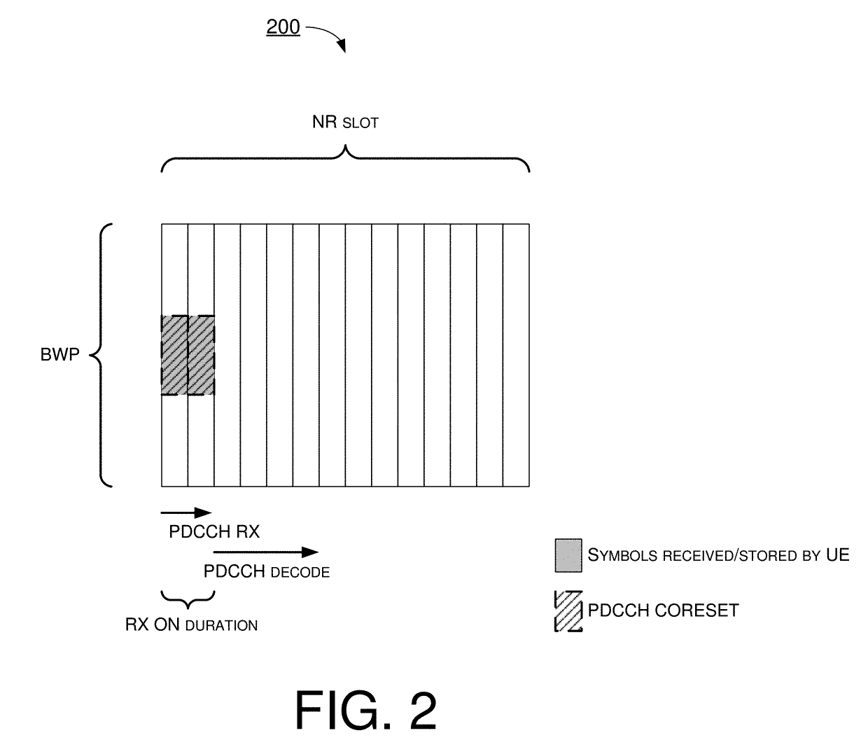

FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network or an NB-IoT network). In scenario 200, the network node may be configured to use cross-slot scheduling for transmitting downlink information to the UE. Under cross-slot scheduling, the UE may only need to receive the control information (e.g., PDCCH) in one slot. The data information (e.g., PDCCH) indicated by the PDCCH will be scheduled in a different slot. The UE may only turn on its transceiver for receiving the PDCCH. After receiving the PDCCH, the UE may turn off its transceiver for power saving. The UE may decode the PDCCH slowly or enable the dynamic voltage frequency scaling (DVFS) operation. In addition, the UE may not need to turn on its transceiver for whole bandwidth part (BWP). The UE may only turn on its transceiver for the control resource set (CORESET) part in frequency domain. The UE may not need to receive symbols apart from those within the CORESET that schedules activity, thereby reducing the number of symbols it has to receive in time as well as the number of subcarriers to receive in frequency. Accordingly, the UE may only need to receive downlink CORESET symbols for the CORESET bandwidth. The UE power consumption can be significantly reduced.

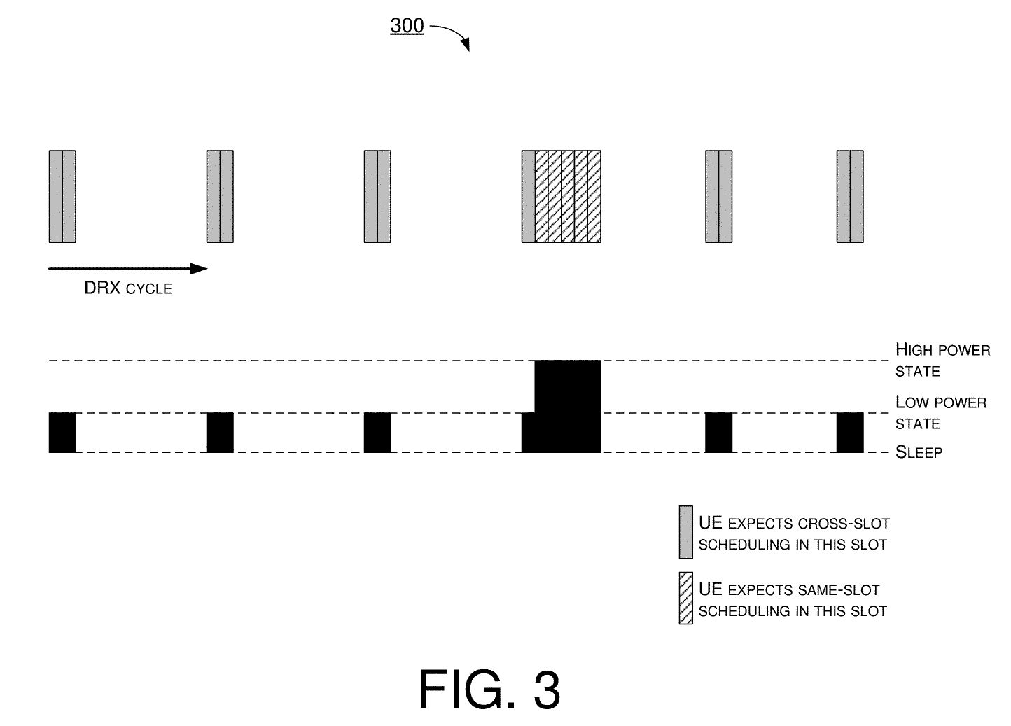

FIG. 3 illustrates an example scenario 300 under schemes in accordance with implementations of the present disclosure. Scenario 300 involves a UE and a network node, which may be a part of a wireless communication network (e.g., an LTE network, an LTE-Advanced network, an LTE-Advanced Pro network, a 5G network, an NR network, an IoT network or an NB-IoT network). The UE may be configured to operate in different power states. For example, the UE may operate in a first power state or a second power state. The first power state may be a high power state (HPS). The second power state may be a low power state (LPS). The network node may be configured to use the cross-slot scheduling to transmit downlink information when the UE is in the LPS. The network node may be configured to use the same-slot scheduling to transmit downlink information when the UE is in the HPS.

The UE may be able to perform a transition between the LPS and the HPS when some certain conditions are triggered. Specifically, the UE may be configured to determine whether a first condition is triggered. The UE may perform a transition from the HPS to the LPS in response to the first condition being triggered. The UE may be configured to receive the downlink information according to the cross-slot scheduling when in the LPS. The first condition may be a timer based condition. For example, the first condition may comprise expiry of an inactivity timer. The UE may be configured to initiate the inactivity timer when there is no uplink activity or downlink activity. The inactivity timer value may be a predetermined value or configured by the network node. When the inactivity timer is expired, the UE may assume that no uplink or downlink transmissions needed to be performed and may transit from the HPS to the LPS for power saving. While in the LPS, the UE may expect the cross-slot scheduling and may monitor/receive the PDCCH according to the cross-slot scheduling.

Alternatively, the first condition may be a DRX based condition. For example, the first condition may comprise activation of the DRX operation. The UE may be configured with a DRX inactivity timer. When the DRX inactivity timer is expired, the UE may enter into a sleep mode and may activate the DRX operation. The UE may transit from the HPS to the LPS for power saving when the DRX operation is activated. In another example, the first condition may comprise entry into a long DRX state. The UE may be configured with the DRX operation. When the UE switches from the short DRX cycle to the long DRX cycle, the UE may transit from the HPS to the LPS for power saving. While in the LPS, the UE may expect the cross-slot scheduling and may monitor/receive the PDCCH according to the cross-slot scheduling.

Alternatively, the first condition may be a bandwidth part (BWP) based condition. For example, the first condition may comprise switching to a predetermined/default BWP. The UE may be configured with a BWP inactivity timer. When the BWP inactivity timer is expired, the UE may switch from a specific BWP to the predetermined/default BWP. The UE may transit from the HPS to the LPS for power saving when switching to the predetermined/default BWP. In another example, the UE may receive a network command from the network node. The network command may indicate the UE to switch to the predetermined/default BWP. In addition, certain BWPs may be classified by the network as the LPS BWPs. The switch to the LPS BWPs may trigger the UE to transit from the HPS to the LPS. While in the LPS, the UE may expect the cross-slot scheduling and may monitor/receive the PDCCH according to the cross-slot scheduling.

Alternatively, the first condition may be a network indication based condition. For example, the first condition may comprise reception of a network indication. The network indication may comprise, for example and without limitation, downlink control information (DCI), medium access control (MAC) control element (CE), radio resource control (RRC) signaling, or other means. The network indication may indicate the UE to expect the cross-slot scheduling or to transit from the HPS to the LPS. After receiving the network indication, the UE may be configured to transit from the HPS to the LPS. While in the LPS, the UE may expect the cross-slot scheduling and may monitor/receive the PDCCH according to the cross-slot scheduling.

Additionally, the UE may also be able to transit from the LPS to the HPS when some certain conditions are triggered. Specifically, the UE may be configured to determine whether a second condition is triggered. The UE may perform the transition from the LPS to the HPS in response to the second condition being triggered. The UE may be configured to receive the downlink information according to the same-slot scheduling when in the HPS. The second condition may be an activity based condition. For example, the second condition may comprise detection of a data activity. The reception of a DCI that schedules downlink data may trigger the UE to transit from the LPS to the HPS. The UE may be configured to detect whether downlink/uplink data activity is presence or scheduled. The UE may transit from the LPS to the HPS for performing downlink/uplink transmissions when the data activity is detected. The transition from the LPS to the HPS may take place immediately or after a delay. For example, the UE may perform the transition after a fixed time or after an uplink transmission such as a hybrid automatic repeat request (HARQ) acknowledgement following a downlink DCI or the transmission of data following an uplink DCI. While in the HPS, the UE may expect the same-slot scheduling and may monitor/receive the PDCCH and PDSCH according to the same-slot scheduling.

Alternatively, the second condition may be a DRX based condition. For example, the second condition may comprise deactivation of the DRX operation. The UE may deactivate the DRX operation and wake up from the sleep mode when the UE receives a DCI or a wake up indication. When the UE wakes up from the sleep mode and expects activity, the UE may transit from the LPS to the HPS state. The transition from the LPS to the HPS may take place immediately or after a delay. While in the HPS, the UE may expect the same-slot scheduling and may monitor/receive the PDCCH and PDSCH according to the same-slot scheduling.

Alternatively, the second condition may be a BWP based condition. For example, the second condition may comprise switching to a specific BWP. The UE may receive a network command from the network node. The network command may indicate the UE to switch from the predetermined/default BWP to the specific BWP. The switch to the specific BWP may trigger the UE to transit from the LPS to the HPS. In addition, certain BWPs may be classified by the network as the HPS BWPs. The switch to the HPS BWPs may trigger the UE to transit from the LPS to the HPS. While in the HPS, the UE may expect the same-slot scheduling and may monitor/receive the PDCCH and PDSCH according to the same-slot scheduling.

Alternatively, the second condition may be a network indication based condition. For example, the second condition may comprise reception of a network indication. The network indication may comprise, for example and without limitation, DCI, MAC CE, RRC signaling, or other means. The network indication may indicate the UE to expect the same-slot scheduling or to transit from the LPS to the HPS. After receiving the network indication, the UE may be configured to transit from the LPS to the HPS. While in the HPS, the UE may expect the same-slot scheduling and may monitor/receive the PDCCH and PDSCH according to the same-slot scheduling.

In some implementations, the network node may be configured to determine when it can use the same-slot scheduling for transmitting downlink information. For example, the network node may determine the use the same-slot scheduling after an uplink transmission. For downlink, the network node may the use same-slot scheduling after it receives HARQ feedback for scheduled downlink data. For uplink, the network node may use the same-slot scheduling after it receives the uplink data that was scheduled. Alternatively, the UE may be configured to transmit an indication to the network node to indicate the transition (e.g., from the HPS to the LPS or from the LPS to the HPS).

In some implementations, the UE may be configured to establish multiple links with at least one of a plurality of network nodes. For example, the UE may establish a first link with a first network node. The first network node may comprise a primary cell (PCell), a primary secondary cell (PSCell), or a master cell group (MCG). The first link may be a primary component carrier. The UE may further establish a second link with a second network node. The second network node may comprise a secondary cell (SCell) or a secondary cell group (SCG). The second link may be a secondary component carrier. The UE may be configured to monitor a single link (e.g., the first link) when in the LPS. The UE may be configured to monitor a plurality of links (e.g., the first link and the second link) when in the HPS.

### Illustrative Implementations

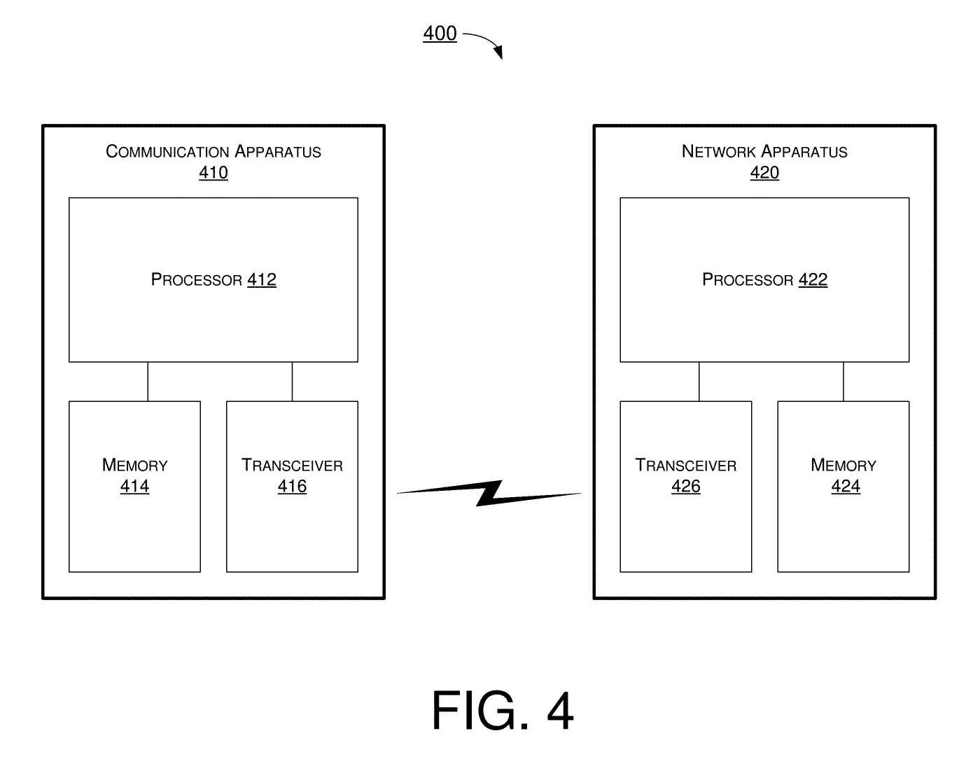

FIG. 4 illustrates an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to power-saving mechanism by cross-slot scheduling with respect to user equipment and network apparatus in wireless communications, including scenarios 100, 200 and 300 described above as well as process 500 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT or NB-IoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a base station, a small cell, a router or a gateway. For instance, network apparatus 420 may be implemented in an eNodeB in an LTE, LTE-Advanced or LTE-Advanced Pro network or in a gNB in a 5G, NR, IoT or NB-IoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more RISC or CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including power consumption reduction in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, processor 422 may be configured to use same-slot scheduling for transmitting downlink information to communication apparatus 410. Under same-slot scheduling, processor 422 may schedule the control information (e.g., PDCCH) and the data information (e.g., PDSCH) in the same slot. Processor 412 may be configured to monitor/receive, via transceiver 416, the PDCCH. After receiving the PDCCH, processor 412 may need processing time to decode and parse the PDCCH. Since processor 412 may assume that there may be downlink data in the same slot, processor 412 may keep its transceiver 416 turned on to receive/store all symbols over the time taken to decode/parse the PDCCH. After determining that there is no downlink data for communication apparatus 410 in the slot, processor 412 may be able to turn off transceiver 416 and stop receiving downlink information.

In some implementations, processor 422 may be configured to use cross-slot scheduling for transmitting downlink information to communication apparatus 410. Under cross-slot scheduling, processor 412 may only need to receive the control information (e.g., PDCCH) in one slot. The data information (e.g., PDSCH) indicated by the PDCCH will be scheduled in a different slot. Processor 412 may only turn on transceiver 416 for receiving the PDCCH. After receiving the PDCCH, processor 412 may turn off transceiver 416 for power saving. Processor 412 may decode the PDCCH slowly or enable the DVFS operation. In addition, processor 412 may not need to turn on transceiver 416 for whole BWP. Processor 412 may only turn on transceiver 416 for the CORESET part in frequency domain. Processor 412 may not need to receive symbols apart from those within the CORESET that schedules activity, thereby reducing the number of symbols it has to receive in time as well as the number of subcarriers to receive in frequency. Accordingly, processor 412 may only need to receive downlink CORESET symbols for the CORESET bandwidth.

In some implementations, processor 412 may be configured to operate in different power states. For example, processor 412 may operate in a first power state or a second power state. The first power state may be a HPS. The second power state may be a LPS. Processor 422 may be configured to use the cross-slot scheduling to transmit downlink information when processor 412 is in the LPS. Processor 422 may be configured to use the same-slot scheduling to transmit downlink information when processor 412 is in the HPS.

In some implementations, processor 412 may be able to perform a transition between the LPS and the HPS when some certain conditions are triggered. Specifically, processor 412 may be configured to determine whether a first condition is triggered. Processor 412 may perform a transition from the HPS to the LPS in response to the first condition being triggered. Processor 412 may be configured to receive, via transceiver 416, the downlink information according to the cross-slot scheduling when in the LPS. The first condition may be a timer based condition. For example, the first condition may comprise expiry of an inactivity timer. Processor 412 may be configured to initiate the inactivity timer when there is no uplink activity or downlink activity. The inactivity timer value may be a predetermined value or configured by network apparatus 420. When the inactivity timer is expired, processor 412 may assume that no uplink or downlink transmissions needed to be performed and may transit from the HPS to the LPS for power saving. While in the LPS, processor 412 may expect the cross-slot scheduling and may monitor/receive, via transceiver 416, the PDCCH according to the cross-slot scheduling.

In some implementations, the first condition may be a DRX based condition. For example, the first condition may comprise activation of the DRX operation. Processor 412 may be configured with a DRX inactivity timer. When the DRX inactivity timer is expired, processor 412 may enter into a sleep mode and may activate the DRX operation. Processor 412 may transit from the HPS to the LPS for power saving when the DRX operation is activated. In another example, the first condition may comprise entry into a long DRX state. Processor 412 may be configured with the DRX operation. When processor 412 switches from the short DRX cycle to the long DRX cycle, processor 412 may transit from the HPS to the LPS for power saving. While in the LPS, processor 412 may expect the cross-slot scheduling and may monitor/receive, via transceiver 416, the PDCCH according to the cross-slot scheduling.

In some implementations, the first condition may be a BWP based condition. For example, the first condition may comprise switching to a predetermined/default BWP. Processor 412 may be configured with a BWP inactivity timer. When the BWP inactivity timer is expired, processor 412 may switch from a specific BWP to the predetermined/default BWP. Processor 412 may transit from the HPS to the LPS for power saving when switching to the predetermined/default BWP. In another example, processor 412 may receive, via transceiver 416, a network command from network apparatus 420. The network command may indicate processor 412 to switch to the predetermined/default BWP. In addition, certain BWPs may be classified by network apparatus 420 as the LPS BWPs. The switch to the LPS BWPs may trigger processor 412 to transit from the HPS to the LPS. While in the LPS, processor 412 may expect the cross-slot scheduling and may monitor/receive, via transceiver 416, the PDCCH according to the cross-slot scheduling.

In some implementations, the first condition may be a network indication based condition. For example, the first condition may comprise reception of a network indication. The network indication may comprise, for example and without limitation, DCI, MAC CE, RRC signaling, or other means. The network indication may indicate processor 412 to expect the cross-slot scheduling or to transit from the HPS to the LPS. After receiving the network indication, processor 412 may be configured to transit from the HPS to the LPS. While in the LPS, processor 412 may expect the cross-slot scheduling and may monitor/receive, via transceiver 416, the PDCCH according to the cross-slot scheduling.

In some implementations, processor 412 may also be able to transit from the LPS to the HPS when some certain conditions are triggered. Specifically, processor 412 may be configured to determine whether a second condition is triggered. Processor 412 may perform the transition from the LPS to the HPS in response to the second condition being triggered. Processor 412 may be configured to receive, via transceiver 416, the downlink information according to the same-slot scheduling when in the HPS. The second condition may be an activity based condition. For example, the second condition may comprise detection of a data activity. The reception of a DCI that schedules downlink data may trigger processor 412 to transit from the LPS to the HPS. Processor 412 may be configured to detect whether downlink/uplink data activity is presence or scheduled. Processor 412 may transit from the LPS to the HPS for performing downlink/uplink transmissions when the data activity is detected. The transition from the LPS to the HPS may take place immediately or after a delay. For example, processor 412 may perform the transition after a fixed time or after an uplink transmission such as a HARQ acknowledgement following a downlink DCI or the transmission of data following an uplink DCI. While in the HPS, processor 412 may expect the same-slot scheduling and may monitor/receive, via transceiver 416, the PDCCH and PDSCH according to the same-slot scheduling.

In some implementations, the second condition may be a DRX based condition. For example, the second condition may comprise deactivation of the DRX operation. Processor 412 may deactivate the DRX operation and wake up from the sleep mode when processor 412 receives a DCI or a wake up indication. When processor 412 wakes up from the sleep mode and expects activity, processor 412 may transit from the LPS to the HPS state. The transition from the LPS to the HPS may take place immediately or after a delay. While in the HPS, processor 412 may expect the same-slot scheduling and may monitor/receive, via transceiver 416, the PDCCH and PDSCH according to the same-slot scheduling.

In some implementations, the second condition may be a BWP based condition. For example, the second condition may comprise switching to a specific BWP. Processor 412 may receive a network command from network apparatus 420. The network command may indicate processor 412 to switch from the predetermined/default BWP to the specific BWP. The switch to the specific BWP may trigger processor 412 to transit from the LPS to the HPS. In addition, certain BWPs may be classified by network apparatus 420 as the HPS BWPs. The switch to the HPS BWPs may trigger processor 412 to transit from the LPS to the HPS. While in the HPS, processor 412 may expect the same-slot scheduling and may monitor/receive, via transceiver 416, the PDCCH and PDSCH according to the same-slot scheduling.

In some implementations, the second condition may be a network indication based condition. For example, the second condition may comprise reception of a network indication. The network indication may comprise, for example and without limitation, DCI, MAC CE, RRC signaling, or other means. The network indication may indicate processor 412 to expect the same-slot scheduling or to transit from the LPS to the HPS. After receiving the network indication, processor 412 may be configured to transit from the LPS to the HPS. While in the HPS, processor 412 may expect the same-slot scheduling and may monitor/receive, via transceiver 416, the PDCCH and PDSCH according to the same-slot scheduling.

In some implementations, processor 422 may be configured to determine when it can use the same-slot scheduling for transmitting downlink information. For example, processor 422 may determine the use the same-slot scheduling after an uplink transmission. For downlink, processor 422 may the use same-slot scheduling after it receives HARQ feedback for scheduled downlink data. For uplink, processor 422 may use the same-slot scheduling after it receives the uplink data that was scheduled. Alternatively, processor 412 may be configured to transmit, via transceiver 416, an indication to network apparatus 420 to indicate the transition (e.g., from the HPS to the LPS or from the LPS to the HPS).

In some implementations, processor 412 may be configured to establish multiple links with at least one of a plurality of network apparatus. For example, processor 412 may establish, via transceiver 416, a first link with a first network apparatus. The first network apparatus may comprise a PCell, a PSCell, or a MCG. The first link may be a primary component carrier. Processor 412 may further establish, via transceiver 416, a second link with a second network apparatus. The second network apparatus may comprise a SCell or a SCG. The second link may be a secondary component carrier. Processor 412 may be configured to monitor, via transceiver 416, a single link (e.g., the first link) when in the LPS. Processor 412 may be configured to monitor, via transceiver 416, a plurality of links (e.g., the first link and the second link) when in the HPS.

### Illustrative Processes

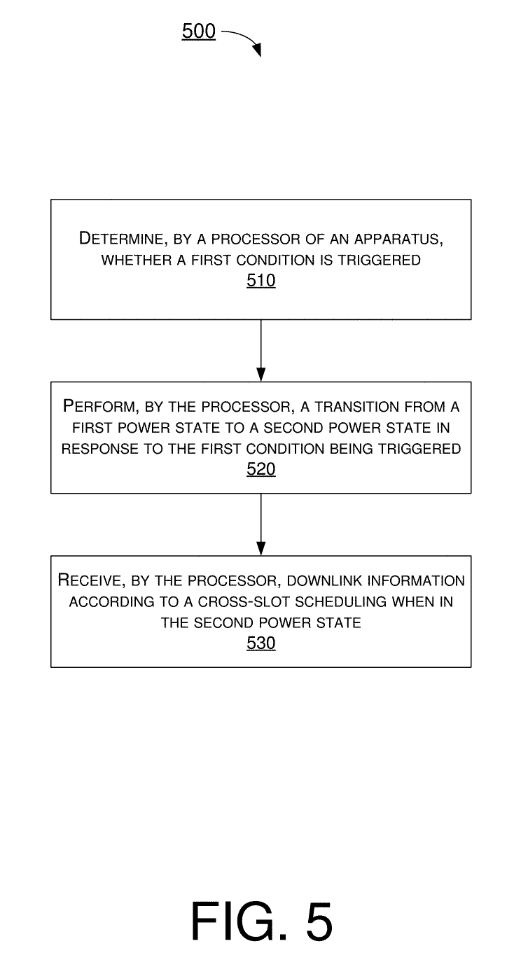

FIG. 5 illustrates an example process 500 in accordance with an implementation of the present disclosure. Process 500 may be an example implementation of scenarios 100, 200 and 300, whether partially or completely, with respect to power-saving mechanism by cross-slot scheduling with the present disclosure. Process 500 may represent an aspect of implementation of features of communication apparatus 410. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of apparatus 410 determining whether a first condition is triggered. Process 500 may proceed from 510 to 520.

At 520, process 500 may involve processor 412 performing a transition from a first power state to a second power state in response to the first condition being triggered. Process 500 may proceed from 520 to 530.

At 530, process 500 may involve processor 412 receiving downlink information according to a cross-slot scheduling when in the second power state.

In some implementations, process 500 may involve processor 412 determining whether a second condition is triggered. Process 500 may also involve processor 412 performing the transition from the second power state to the first power state in response to the second condition being triggered. Process 500 may further involve processor 412 receiving the downlink information according to a same-slot scheduling when in the first power state.

In some implementations, the first power state may comprise a HPS. The second power state may comprise a LPS.

In some implementations, the first condition may comprise at least one of expiry of an inactivity timer, entry into a long DRX state, switching to a predetermined bandwidth part, and reception of a network indication.

In some implementations, the second condition may comprise at least one of detection of a data activity, switching to a specific bandwidth part, and reception of a network indication.

In some implementations, process 500 may involve processor 412 transmitting an indication to a network node to indicate the transition.

In some implementations, process 500 may involve processor 412 receiving control information and data information in different slots respectively.

In some implementations, process 500 may involve processor 412 receiving control information and data information in one slot.

In some implementations, process 500 may involve processor 412 monitoring a single link when in the second power state.

In some implementations, process 500 may involve processor 412 monitoring a plurality of links when in the first power state.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, whether a first condition is triggered;
performing, by the processor, a transition from a first power state to a second power state in response to the first condition being triggered; and
receiving, by the processor, downlink information according to a cross-slot scheduling when in the second power state.

2. The method of claim 1, further comprising:
determining, by the processor, whether a second condition is triggered;
performing, by the processor, a transition from the second power state to the first power state in response to the second condition being triggered; and
receiving, by the processor, the downlink information according to a same-slot scheduling when in the first power state.

3. The method of claim 1, wherein the first power state comprises a high power state, and wherein the second power state comprises a low power state.

4. The method of claim 1, wherein the first condition comprises at least one of expiry of an inactivity timer, entry into a long discontinuous reception (DRX) state, switching to a predetermined bandwidth part, and reception of a network indication.

5. The method of claim 2, wherein the second condition comprises at least one of detection of a data activity, switching to a specific bandwidth part, and reception of a network indication.

6. The method of claim 1, further comprising:
transmitting, by the processor, an indication to a network node to indicate the transition.

7. The method of claim 1, wherein the receiving of the downlink information according to the cross-slot scheduling comprises receiving control information and data information in different slots respectively.

8. The method of claim 2, wherein the receiving of the downlink information according to the same-slot scheduling comprises receiving control information and data information in one slot.

9. The method of claim 1, further comprising:
monitoring, by the processor, a single link when in the second power state.

10. The method of claim 2, further comprising: monitoring, by the processor, a plurality of links when in the first power state.

11. An apparatus, comprising:
a transceiver capable of wirelessly communicating with a network node of a wireless network; and
a processor communicatively coupled to the transceiver, the processor capable of:
determining whether a first condition is triggered;
performing a transition from a first power state to a second power state in response to the first condition being triggered; and
receiving, via the transceiver, downlink information according to a cross-slot scheduling when in the second power state.

12. The apparatus of claim 11, wherein the processor is further capable of:
determining whether a second condition is triggered;
performing a transition from the second power state to the first power state in response to the second condition being triggered; and
receiving, via the transceiver, the downlink information according to a same-slot scheduling when in the first power state.

13. The apparatus of claim 11, wherein the first power state comprises a high power state, and wherein the second power state comprises a low power state.

14. The apparatus of claim 11, wherein the first condition comprises at least one of expiry of an inactivity timer, entry into a long discontinuous reception (DRX) state, switching to a predetermined bandwidth part, and reception of a network indication.

15. The apparatus of claim 12, wherein the second condition comprises at least one of detection of a data activity, switching to a specific bandwidth part, and reception of a network indication.

16. The apparatus of claim 11, wherein the processor is further capable of:
transmitting, via the transceiver, an indication to the network node to indicate the transition.

17. The apparatus of claim 11, wherein, in receiving the downlink information according to the cross-slot scheduling, the processor is capable of receiving control information and data information in different slots respectively.

18. The apparatus of claim 12, wherein, in receiving the downlink information according to the same-slot scheduling, the processor is capable of receiving control information and data information in one slot.

19. The apparatus of claim 11, wherein the processor is further capable of:
monitoring, via the transceiver, a single link when in the second power state.

20. The apparatus of claim 12, wherein the processor is further capable of:
monitoring, via the transceiver, a plurality of links when in the first power state.
